(19) United States
(12) Patent Application Publication
(10) Pub. No.: US 2010/0231610 A1
(43) Pub. Date: Sep. 16, 2010

(54) SYSTEM AND METHOD FOR IMPROVING BATTERY LIFE IN AN ELECTRONIC DEVICE

(75) Inventors: Brent Hoffman, Mooresville, IN (US); Mark R. Anderson, Indianapolis, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/679,090

(22) PCT Filed: Oct. 31, 2007
(86) PCT No.: PCT/US07/83200

§ 371 Date: Mar. 19, 2010

(30) Foreign Application Priority Data
Oct. 18, 2007 (CN) 200710124031.8

(51) Int. Cl. G09G 5/00

(52) U.S. Cl. 345/660

(57) ABSTRACT

A method of conserving battery life in an electronic device comprises receiving a low power user image size preference. The method additionally comprises adjusting an image size responsive to a user request to invoke the low power user image size preference so that an adjusted image displayed by the electronic device occupies an image zone that is smaller than an entire display size of the electronic device, and illuminating only areas within the image zone.

### FIELD OF THE INVENTION

The present invention relates generally to display systems. More specifically, the present invention relates to a system and method for reducing power consumption in display systems.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Portability has become an increasingly important characteristic of display products. Display products such as laptops or mobile computers, personal digital assistants, and mobile telecommunication devices have become widespread largely due to the flexibility and convenience they provide through portability. However, obtaining portability often requires the display device to be powered by a battery source, and a short battery life may decrease the benefits of portability and usefulness of the device in general.

In portable products with relatively large screens, a relatively large portion of power needed to operate the device is consumed by the light sources that illuminate the display. Therefore, portable electronic devices with large displays running on battery power may experience a relatively limited battery life. One method of extending battery life for portable displays has been to decrease the light illumination of the display. However, this method conserves battery life at some expense to display performance. Dimmed illumination may cause difficulties in viewing because of low contrast and brightness. A more efficient method of extending battery life for portable display devices is desired.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a block diagram of a user input interface processing system that is useful in explaining the processing of user inputs for image and border illumination settings in accordance with an exemplary embodiment of the present invention; and

FIG. 3 is a flow chart depicting a method for obtaining illumination settings in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Electronic devices powered by batteries have a useful run time determined in part by the life of the batteries. This includes portable display products such as portable LCD displays that are powered by batteries. The run time of such devices is further limited by the power required by the display. For devices with a relatively large screen size, a large percentage of the total power consumed is used to illuminate the display area. An exemplary embodiment of the present invention extends battery life in an electronic device by removing illumination from selective zones of the display area at opportunistic times (e.g., when certain portions of the display are not in use).

Backlighting systems for display devices may comprise multiple types of light sources, such as cold cathode fluorescent lamps (CCFLs) or light emitting diodes (LEDs). Such light sources may be equally and geometrically spaced across the display area such that each light source is responsible for lighting a specific portion of the display. Therefore, an electronic device may turn off a zone of the display by turning off the light sources in that zone. Thus, the illuminated area of the display is decreased, power is conserved, and the run time of the battery and the electronic device is extended.

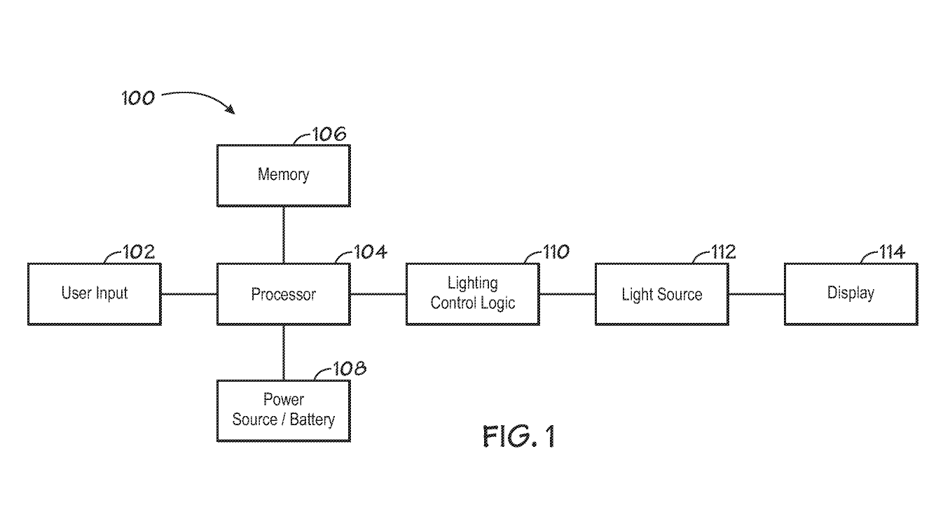

FIG. 1 is a block diagram of an electronic device in accordance with an exemplary embodiment of the present invention. The electronic device (e.g., a display) is generally referred to by the reference number 100. The electronic device 100 comprises a user input interface 102, a processor 104, a memory 106, a power source 108, a lighting control logic 110, a light source 112, and a display 114. Those of ordinary skill in the art will appreciate that the various functional blocks shown in FIG. 1 may comprise hardware elements (including circuitry), software elements (including computer code stored on a machine-readable medium) or a combination of both hardware and software elements.

The memory 106 may be adapted to hold machine-readable computer code that causes the processor 104 to perform an exemplary method in accordance with the present invention. The lighting control logic 110 may be adapted to receive output from the processor and control the status of the light source 112 in response thereto. The light source 112 may be adapted to illuminate the display 114, and may comprise CCFLs, LEDs, or any other light source appropriate for illuminating a display 114. Furthermore, the light source 112 may be spaced such that the processor 104 and/or the lighting control logic 110 may cause individual light sources or groups of light sources to be turned off or on to selectively illuminate only the identified image zones of the display area.

In one exemplary embodiment, the electronic device 100 may turn off illumination in display zones corresponding to a border of the image so that only the image itself is illuminated. For example, an LCD display panel displaying a wide screen movie would have borders across the top and bottom of the display. Since the borders are not part of the image, the light sources in the zones of the display area corresponding to borders may be turned off. Thus, power may be conserved without jeopardizing the quality of the image.

In another exemplary embodiment, the electronic device 100 may reduce the image size such that it occupies a smaller portion of the display area. For example, if an LCD display panel has a resolution of 1280×720, then some number of individual light sources could illuminate the entire 1280×720 pixel array. An image could likewise occupy the entire 1280×720 pixel array. However, a user may choose to decrease the size of the image, thereby decreasing the area of the illuminated display. If a user chooses to display an image at only 25% of the display size, the electronic device 100 may receive this low power user image size preference and adjust the image size responsive to the low power user image size preference request so that the adjusted image displayed by the electronic device 100 occupies an image zone that is smaller than the entire display size. In this example, the processor 104 and/or the lighting control logic 110 may reduce the image size so that rather than occupying the entire 1280×720 pixel array (921,600 pixels), the image would only occupy a 640×360 pixel array (230,400 pixels). Light sources within the image zone would be illuminated, and light sources outside the image zone would not be illuminated.

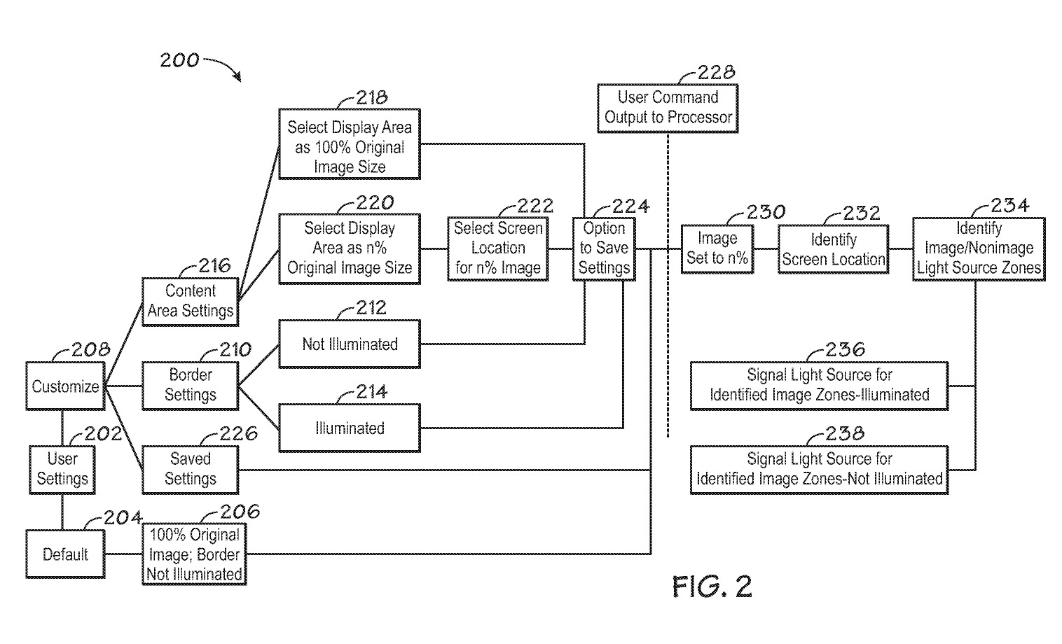

FIG. 2 is a block diagram of a user input interface and processing system that is useful in explaining the processing of user inputs for image and border illumination settings in accordance with an exemplary embodiment of the present invention. The block diagram of FIG. 2 is generally referred to by reference numeral 200. Specifically, FIG. 2 illustrates one exemplary embodiment of display area and illumination options that are controllable by user inputs. From a user setting menu 202, a user may choose a default option 204. For example, as represented by block 206, the default option may display the image at 100% of the original size and turn off illumination for display zones identified as the border.

Additionally, the user may choose a customize option 208, enabling selection of the border settings, as represented by block 210; borders may either be illuminated (block 214) or not illuminated (block 212). The user may also input the display content area settings, as represented by block 216, to either select the display area as 100% of the original image size, as represented by block 218, or select the display area as a certain percentage (n %) of the original image size, as represented by block 220. Selecting n % of the original image also allows the user to select a location, as represented by block 222, on the display screen of which the n % image will appear. After choosing the content area setting and border setting, the user may then save the settings at block 224 so that the customized image display settings may be more quickly reached from the customized save settings menu option (block 226) the next time the device is in use.

At block 228, the user command is delivered to the processor 104 (FIG. 1) and/or the lighting control logic 110 (FIG. 1), which operate to set or reduce the image size to n %, as represented by block 230. If n % is set to 100%, the image size would not need to be reduced. The appropriate screen location is identified at block 232, as according to the user option (block 222). The processor 104 (FIG. 1) then identifies image and non-image light source zones in block 234. Non-image zones from which illumination may be removed include the border areas and all areas outside of an n % image. In one exemplary embodiment, if the user commanded that an image with an original size of 1280×720 pixel array (921,600 pixels) be shrunk to 25% and displayed in the upper right corner of the display screen, then the processor 104 (FIG. 1) would identify the adjusted display area in the upper right corner of the display screen with a 640×360 pixel array (230,400 pixels) as an image zone, and all areas outside of that image zone as a non-image zone. Additionally, if the user requests the image to be displayed at 100% of its original size and for the borders to also be illuminated, then the whole display screen is treated as an image zone and there are no non-image zones. After the adjusted display area is identified on the display screen, the processor 104 (FIG. 1) via the lighting control logic 110 (FIG. 1) would signal for light sources in the identified image zones to be illuminated, as represented by block 236, and for the light sources in the identified non-image zones to be not illuminated, as represented by block 238.

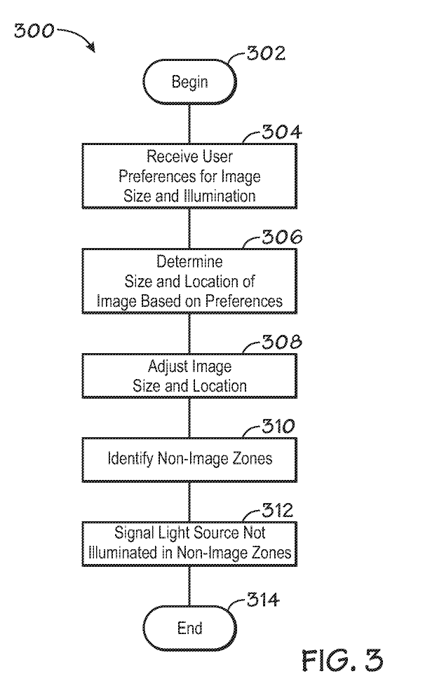

FIG. 3 is a flow chart depicting a method for obtaining illumination settings in accordance with an exemplary embodiment of the present invention. The method for obtaining illumination settings as depicted in the flow chart may generally be referred to by reference numeral 300. The method begins at block 302. User preferences for image size and illumination are received, as represented by block 304, for example, from the memory 106 (FIG. 1). Then, based on the preferences, the size and location of the image is determined in block 306 by the processor 104 (FIG. 1). The size and location of the image is adjusted by the processor 104 (FIG. 1) at block 308, and the non-image zones are identified by the processor 104 (FIG. 1) at block 310. Finally, the light sources in non-image zones are signaled to not illuminate, as represented by block 312. In an alternative embodiment, rather than determining the non-image zones in block 310 and signaling for light sources in non-image zones to be not illuminated in block 312, the image zones may be determined, and the light sources in the image zones signaled to illuminate. Also, those of ordinary skill in the art will appreciate that processing methods may employ some combination of determining image and non-image zones and signaling light sources in certain zones to be illuminated or not illuminated, depending on individual system design considerations.

In another exemplary embodiment of the present invention, fixed choices of image sizes may also be made available to a user. For example, the electronic device 100 (FIG. 1) may offer to display the full image size along with a corresponding battery life estimate, or a reduced image size along with a corresponding battery life estimate. In accordance with an exemplary embodiment of the present invention, Table 1 (below) depicts possible user options of full or reduced image sizes, along with their corresponding battery life estimates. Furthermore, battery life estimates may be offered in other embodiments where the user inputs a customized image size.

TABLE 1
Battery Life with 5 A * hr battery

| Display | Backlight | Other | Total | Battery |
|---|---|---|---|---|
| Area | Power | Power | Power | Life |
| used | (Amp) | (Amp) | (Amp) | (Hr) |
| 100% | 2 | 0.5 | 2.5 | 2.0 |
| 80% | 1.6 | 0.5 | 2.1 | 2.4 |
| 60% | 1.2 | 0.5 | 1.7 | 2.9 |
| 50% | 1 | 0.5 | 1.5 | 3.3 |
| 40% | 0.8 | 0.5 | 1.3 | 3.8 |

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of conserving battery life in an electronic device, comprising:
receiving a low power user image size preference;
adjusting an image size responsive to a user request to invoke the low power user image size preference so that an adjusted image displayed by the electronic device occupies an image zone that is smaller than an entire display size of the electronic device; and
illuminating only areas within the image zone.

2. The method recited in claim 1, wherein the low power user image size preference and the adjusted image is any range of size smaller than the entire display size.

3. The method recited in claim 1, wherein the image zone does not include borders.

4. The method recited in claim 1, comprising:
receiving a user image location preference, wherein the image location preference is a location on a display of the electronic device for displaying the adjusted image; and
positioning the adjusted image location responsive to user request so that a positioned and adjusted image displayed by the electronic device occupies an image zone corresponding to the image location preference.

5. The method recited in claim 1, comprising:
receiving a default user image size preference comprising an automatic image size setting; and
adjusting an image size responsive to a default user image size preference so that a default image size displayed by the electronic device occupies an image zone corresponding to the default user image size preference.

6. The method recited in claim 4, comprising:
saving the low power user image size preference and the user image location preference, wherein a saved preference is produced; and
adjusting the image size and positioning the adjusted image location responsive to the saved preference so that the adjusted and positioned image displayed by the electronic device occupies an image zone corresponding to the saved preference.

7. The method recited in claim 1, wherein the recited acts are performed in the order in which they are recited.

8. An electronic device, comprising:
a display that is adapted to display an image;
a light source that is adapted to illuminate the display; and
a processor that is adapted to:
receive a low power user image size preference;
adjust an image size of the display responsive to a user request to invoke the low power user image size preference so that an adjusted image displayed on the display occupies an image zone that is smaller than an entire display size of the display; and
illuminate the display only within the image zone.

9. The electronic device recited in claim 8, wherein the processor is adapted to:
receive a user image location preference, which is a location on the display for displaying the adjusted image; and
position the adjusted image location responsive to the user image location preference so that an adjusted and positioned image displayed on the display occupies an image zone corresponding to the image location preference.

10. The electronic device recited in claim 8, wherein the processor is adapted to:
receive a default user image size preference comprising an automatic image size setting; and
adjust an image size of the display responsive to a default user image size preference so that a default image size displayed by the electronic device occupies an image zone corresponding to the default user image size preference.

11. The electronic device recited in claim 9, wherein the processor is adapted to:
save the low power user image size preference and the user image location preference, wherein a saved preference is produced; and
adjust the image size and position the adjusted image location responsive to the saved preference so that the adjusted and positioned image displayed by the electronic device occupies an image zone corresponding to the saved preference.

12. The electronic device recited in claim 8, wherein the low power user image size preference and the adjusted image is any range of size smaller than the entire display size.

13. The electronic device recited in claim 8, wherein the image zone does not include borders.

14. The electronic device recited in claim 8, wherein the electronic device comprises a portable display device.

15. The electronic device recited in claim 14, wherein the electronic device comprises a television.

16. The electronic device recited in claim 8, wherein the electronic device is battery powered.

17. An electronic device that conserves battery life, the electronic device comprising:
means for receiving a low power user image size preference;
means for adjusting an image size responsive to a user request to invoke the low power user image size preference so that an adjusted image displayed by the electronic device occupies an image zone that is smaller than an entire display size of the electronic device; and
means for turning display illumination off outside the image zone.

18. The electronic device recited in claim 17, wherein the low power user image size preference and the adjusted image is any range of size smaller than the entire display size.

19. The electronic device recited in claim 17, wherein the image zone does not include borders.

20. The electronic device recited in claim 17, wherein the electronic device comprises a battery powered display device.
